(19) United States
(12) Patent Application Publication
(10) Pub. No.: US 2005/0162623 A1
(43) Pub. Date: Jul. 28, 2005

(54) Projection device

(76) Inventors: Peter Wynne Wilson, Greenwood (GB); Rainer Jessl, Linz (AT)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/498,464

(22) PCT Filed: Dec. 10, 2002
(86) PCT No.: PCT/GB02/05601

(30) Foreign Application Priority Data
Dec. 10, 2001 (GB) 01294958

(51) Int. Cl. G03B 21/28

(52) U.S. Cl. 353/98

(57) ABSTRACT

In a digital image projector, a deflector array, for deflecting light in a chosen direction towards the projection surface, houses a digital image generator, such as a digital micro-mirror device (DMD). While light passes through the deflector array, the image generator receives a digital image signal and modulates the light, producing the image beam. In a double-mirror array, the image generator may be located after both mirrors, or between the two mirrors. Where the image generator is a DMD, one of the mirrors is replaced by the DMD itself.

This invention is directed to the projection of moving light beams, and in particular aspects to the projection of a moving image beam.

Various techniques for the projection of moving light beams for use with images are known in the art. Reference is directed for example to PCT/GB99/00455.

It has also previously been recognized that projectors designed for video or graphics use can be used with advantage for lighting effects if combined with some means for moving the image beam. For example, EP-A-0-932-846 discloses a projection system having an image projector and a rotatable mirror for guiding an image beam over a projection surface. In PCT/GB01/04035, there is disclosed a double-mirror system mounted on an image projector, producing various image projection and lighting effects.

Such systems have the disadvantage that the characteristics of the essentially video or graphics projector are often not ideal for moving image beam applications, such as stage lighting. It is therefore an object of the present invention to address these issues and to provide an improved projection system.

Accordingly, the invention consists in one aspect in an image projection device, comprising a light source, a deflector array for deflecting light produced by the light source in a chosen direction towards a projection surface, and a digital image generator adapted to receive a digital image signal, whereby light from the source is deflected by a deflector, received by the image generator and modulated by the image generator to produce an image beam for projection onto the projection surface.

This device may therefore be used with a simple projector or light pipe, resulting in a far more versatile image projection system.

Advantageously, a deflector of the array comprises the image generator.

Suitably, a deflector of the array is disposed to receive the image beam from the image generator and deflect the image beam towards the projection surface.

Preferably, the device comprises collimation means disposed between the light source and the array for producing a light beam.

Suitably, the deflectors are adapted to be rotated around the axis of incidence of the light to be deflected, whereby the projected image beam may be moved over the projection surface. Preferably, the image generator is rotatable cooperatively with at least one of the deflectors.

Another aspect of the invention consists in an image projection device, comprising a light source and a deflection means for deflecting light produced by the light source in a chosen direction towards a projection surface, the deflection means comprising an image generator rotatable about the axis of incidence of light from the light source, whereby light from the light source is modulated by the image generator to produce an image beam for projection and rotatably steered by the image generator to provide movement of the image beam over the projection surface.

Advantageously, the deflection means comprises an array of deflectors, one of the deflectors being the image generator.

Preferably, the device comprises collimation means disposed between the light source and-the deflection means for producing a light beam.

In a further aspect of the invention, there is provided a beam steering image generation unit for mounting on a light source, comprising a deflection means for deflecting light produced by the light source in a chosen direction towards a projection surface and rotatable about the axis of incidence of light from the light source, and a digital image generator adapted to receive a digital image signal, whereby light from the light source is modulated by the image generator to produce an image beam for projection and rotatably steered by the deflection means to provide movement of the image beam over the projection surface.

The invention will now be described by way of example with reference to the accompanying drawings, in which:

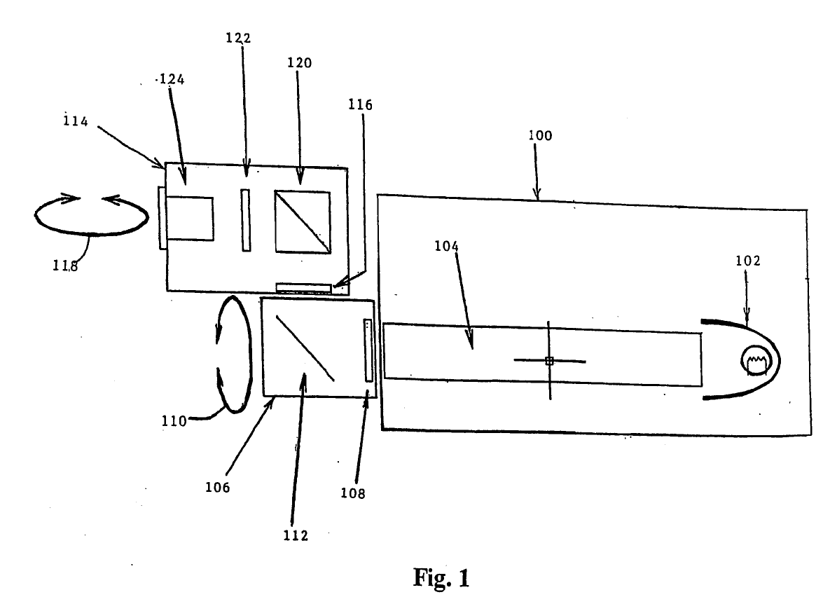

FIG. 1 is a diagram illustrating an image projection device according to an embodiment of the invention; and

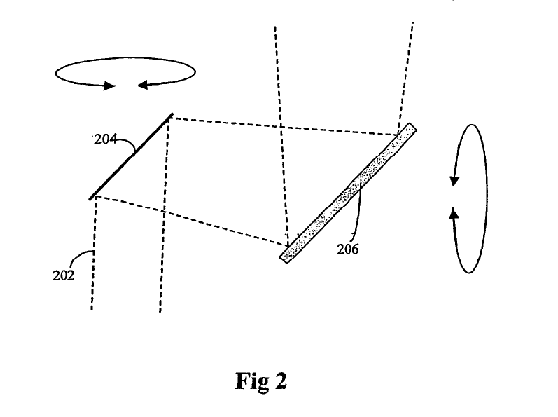

FIG. 2 is a diagram illustrating an image projection device according to another embodiment of the invention.

With reference to FIG. 1, in contrast to image projection devices according to the art, the projector housing (100) of the embodiment illustrated contains only the lamp and reflector assembly (102) and a homogenizing tube (104), rather than a full image projection assembly. Other arrangements for providing a coherent projection light source will, of course, be apparent to those skilled in the art.

The projection beam enters the first section (106) of the double mirror array, which is able to rotate about the bearing (108) in the direction indicated by arrow 110. The light is reflected from mirror (112) into the second section of the array (114).

The second section (114) is rotatable about bearing 116 in the direction shown at 118. The beam from the first section (106) is reflected by a second mirror (120) and then passes through an image generator (122) to create the image bearing beam. The beam is then focused by a lens (124) to produce the output beam. The rotation of the first and second sections about the axes indicated allows the tracking of the output image beam over the whole of a given projection surface. This technique is described in more detail in PCT/GB99/00455.

It should be noted that the bearings (108, 116) are drawn in schematic form only; the bearings are arranged so as not to interfere with light entering the two sections (106, 114) of the apparatus. A variety of means for permitting rotation of the two sections (106, 114) will, of course, be apparent to the skilled reader.

In an alternative embodiment, illustrated in FIG. 2, the second mirror is replaced by a reflective image generator (206), such as a digital micro-mirror device (DMD), such as that described in U.S. Pat. No. 5,083,857. This removes the need for the image generator (122) disposed before the lens (124) in FIG. 1. Light entering the system, indicated by dotted lines 202, strikes the first mirror (204), and is reflected towards the DMD (206), which in turn reflects the resultant image beam towards the lens and output aperture (not shown). Typically the DMD is arranged such that the mirror angle for pixels producing output directs the light towards the output direction. Those pixels which are “off”, direct the light towards a light absorber (not shown) in the known manner.

In further alternatives, the image generator may be in other positions, such as between the two mirrors.

The system provided by embodiments of the invention thus removes the need for a specialized projector. The system may be supplied with a standard projector, or may even be retrofitted to existing lights; This is particularly-useful in the stage lighting environment, where a fully integrated image projector may not be required. Image projectors are commonly cumbersome and may often be impractical. The system of the invention could, for example, be used with the present house lights, such as spotlights, of a given theatre or arena.

A further problem with image projection systems of the art is that the means used to guide or steer the image beam over the projection surface introduces distortions into the image. For example, an image deflected by a mirror rotating about the axis of the incident image beam will itself be rotated as the mirror swivels, until it is eventually upside down. Known projection systems counter these distortions by correcting for the errors in some fashion, either by rotating the apparatus or image generator, or by processing the image data before it is sent to the image generator. However, this introduces far greater complexity into the projector, and slows the speed of response of the projector to instructions.

It is therefore a further advantage of aspects of the present invention that the image generator is positioned after the mirror which rotates around the image beam axis, thus the need for correction of such distortions is removed. In both the embodiment having the image generator positioned in front of the second mirror, as shown in FIG. 1, and the alternative, where an image generator is substituted for the second mirror, as shown in FIG. 2, there will hence be no requirement for correction. Additionally, in the embodiment shown in FIG. 2, the image data input to the DMD may be pre-processed to compensate for any identified aberrations or distortions produced by any of the preceding apparatus.

In embodiments where the image generator is positioned before the mirror introducing the distortion, correction will, of course, be required. However, the device will retain the advantage of retrofitting with a standard projector or simple light pipe.

It will be appreciated by those skilled in the art that the invention has been described by way of example only, and a wide variety of alternative approaches may be adopted.

1. An image projection device, comprising a light source, director for directing light produced by the light source in a chosen direction towards a projection surface, and a digital image generator adapted to receive a digital image signal, whereby light from the source is directed by a the director, received by the image generator and modulated by the image generator to produce an image beam for projection onto the projection surface.

2. A device according to claim 16, wherein a deflector of the array comprises the image generator.

3. A device according to claim 16, wherein a deflector of the array is disposed to receive the image beam from the image generator and deflect the image beam towards the projection surface.

4. A device according to claim 1, comprising a collimator disposed between the light source and the array for producing a light beam.

5. A device according to claim 16, wherein the deflectors are adapted to be rotated around the axis of incidence of the light to be deflected, whereby the projected image beam may be moved over the projection surface.

6. A device according claim 5, wherein the image generator is rotatable cooperatively with at least one of the deflectors.

7. An image projection device, comprising a light source and a deflector for deflecting light produced by the light source in a chosen direction towards a projection surface, the deflector comprising an image generator rotatable about the axis of incidence of light from the light source, whereby light from the light source is modulated by the image generator to produce an image beam for projection and rotatably steered by the image generator to provide movement of the image beam over the projection surface.

8. A device according to claim 7, wherein the deflector comprises an array of deflectors, one of the deflectors being the image generator.

9. A device according to claim 7, comprising a collimator disposed between the light source and the deflector for producing a light beam.

10. A beam steering image generation unit for mounting on a light source, comprising a director for directing light produced by the light source in a chosen direction towards a projection surface and rotatable about the axis of incidence of light from the light source, and a digital image generator adapted to receive a digital image signal, whereby light from the light source is modulated by the image generator to produce an image beam for projection and rotatably steered by the director to provide movement of the image beam over the projection surface.

11. A device according to claim 10, wherein the director comprises an array of deflectors, one of the deflectors being the image generator.

12. A device according to claim 10, comprising a collimator for collimating light from the light source before the director.

13. A method of image projection, comprising the steps of: receiving light from a light source; directing the light in a chosen direction towards a projection surface; and modulating the light by means of a digital image generator to produce an image beam for projection.

14. A method according to claim 13, including the step of moving the digital image generator cooperatively with the directing of the light.

15. A method according to claim 14, wherein the steps of moving the digital image generator and directing the light are performed by rotating a digital micro-mirror device.

16. A device according to claim 1, wherein said deflector comprises an array of deflectors.
